(19) United States
(12) Patent Application Publication
(10) Pub. No.: US 2006/0076278 A1
(43) Pub. Date: Apr. 13, 2006

(54) Screen device

(75) Inventor: Yoshihiko Aikawa, Shizuoka (JP)

Correspondence Address: KANESAKA BERNER AND PARTNERS LLP, SUITE 300, 1700 DIAGONAL RD, ALEXANDRIA, VA, 22314-2848, US

(73) Assignee: AIKAWA IRON WORKS CO., LTD., Shizuoka (JP)

(21) Appl. No.: 11/172,836

(22) Filed: Jul. 5, 2005

(30) Foreign Application Priority Data
Sep. 27, 2004 (JP) 2004-278724

(51) Int. Cl. B07B 1/20

(52) U.S. Cl. 209/306; 162/55; 209/305

(57) ABSTRACT

A screen device includes a tank for receiving a papermaking raw material; a screen with a cylindrical shape for dividing the tank into first and second chambers; a papermaking raw material supplying path for supplying the papermaking raw material to the tank; a foreign material discharging path for discharging the papermaking raw material containing a foreign material; a papermaking raw material discharging path for discharging the papermaking raw material passing through the screen to outside the tank; a cylindrical member disposed in the first chamber to face the screen; a plurality of first foils provided on the cylindrical member; and an extending member extending from a side surface of the cylindrical member. A plurality of second foils extends downwardly from an outer edge of the extending member. The first foil has a projecting portion projecting from the cylindrical member and a hanging member situated away from the cylindrical member.

### BACKGROUND OF THE INVENTION AND RELATED ART STATEMENT

The invention relates to a screen device, especially a screen device with improved screening efficiency.

In a screen device, a foil is disposed inside a screen for mixing a papermaking raw material, so that good fibers in the papermaking raw material pass through the screen and foreign materials in the papermaking raw material do not pass through the screen (for example, refer to Patent Reference 1).

Patent Reference 1: Japanese Patent No. 31902,34 (FIG. 34)

In the screen device, the foil mixes the papermaking raw material, and the good fibers in the papermaking raw material pass through the screen. The papermaking raw material is guided toward a downstream side without disturbance of flow. The papermaking raw material not passing through the screen still contains a large amount of good fibers. Accordingly, it is necessary to improve screening efficiency.

In view of the problem described above, an object of the present invention is to provide a screen device with improved screening efficiency.

Further objects and advantages of the invention will be apparent from the following description of the invention.

### SUMMARY OF THE INVENTION

In order to attain the objects described above, according to the present invention, a screen device comprises a tank for receiving a papermaking raw material; a screen with a cylindrical shape for dividing the tank into a first chamber and a second chamber; a papermaking raw material supplying path communicating with the first chamber for supplying the papermaking raw material to the tank; a foreign material discharging path communicating with the first chamber for discharging the papermaking raw, material containing a foreign material and not passing through the screen to outside the tank; a papermaking raw material discharging path communicating with the second chamber for discharging the papermaking raw material passing through the screen to outside the tank; a cylindrical member disposed in the first chamber to face the screen and connected to a rotating axis; a first foil provided on the cylindrical member; an extending member extending from a side surface of the cylindrical member; and a second foil extending downwardly from an edge surface of the extending member. The first foil has a projecting portion projecting from the side surface of the cylindrical member and a hanging member extending downwardly from the projecting portion and situated away from the side surface of the cylindrical member.

In the screen device, the extending member extends from the side surface of the cylindrical member for preventing the papermaking raw material from flowing, toward a downstream side. When the first foil rotates, the papermaking raw material is discharged with a higher pressure. The hanging member of the first foil is situated away from the side surface of the cylindrical member, so that a part of the papermaking raw material flows upwardly with a less pressure. (If the hanging member of the first foil simply extends from the side surface of the cylindrical member and is not situated away from the side surface of the cylindrical member, the papermaking raw material hits against the extending member, and the hanging member of the first foil prevents the papermaking raw material from flowing upwardly). Accordingly, a part of the papermaking raw material flows upwardly toward an upper side of the first foil along the cylindrical member, thereby making the papermaking raw material to stay longer.

As a result, useful fibers in the papermaking raw material pass through the screen, thereby improving a yield of the papermaking raw material. That is, the papermaking raw material stays in the tank for a long time, thereby improving the screening efficiency.

### BRIEF DESCRIPTION OF THE DRAWINGS

FIG. 1 is a cross sectional view showing a screen device according to an embodiment of the present invention;

FIG. 2 is a partially enlarged cross sectional view of the screen device shown in FIG. 1;

FIG. 3 is a cross sectional view taken along line 3-3 in FIG. 1;

FIG. 4 is a perspective view of a cylindrical member shown in FIG. 1;

FIG. 5 is a cross sectional view of the cylindrical member shown in FIG. 1; and

FIG. 6 is a cross sectional view showing a screen device according to another embodiment of the present invention.

### DETAILED DESCRIPTION OF PREFERRED EMBODIMENTS

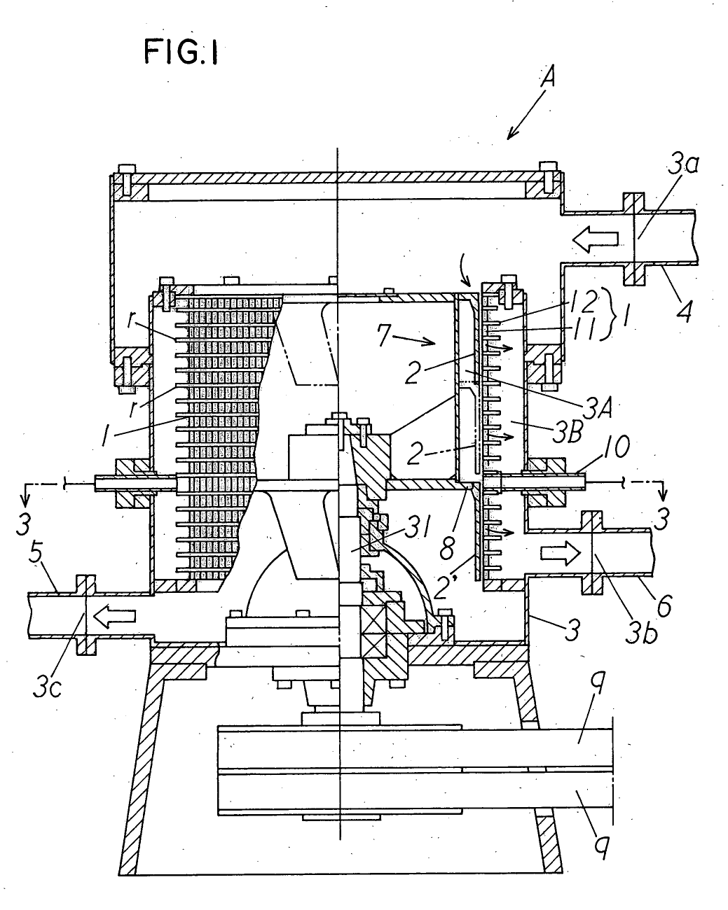

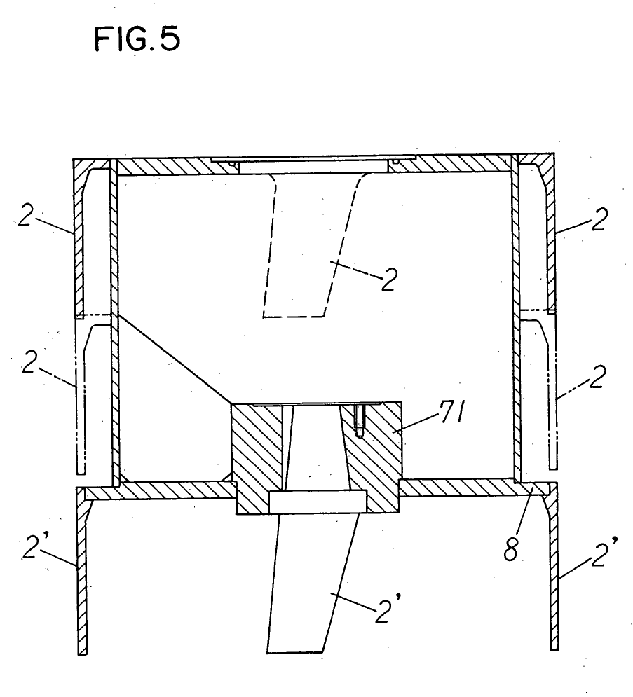

Hereunder, embodiments of the present invention will be explained with reference to the accompanying drawings. As shown in FIGS. 1 to 5, in a screen device A, first foils 2 face an inner side of a cylinder shaped screen 1, and rotate to supply a papermaking raw material to the cylinder shaped screen 1, thereby separating fibers and foreign materials in the papermaking raw material. Further, the first foils 2 wash the cylinder shaped screen 1, so that the foreign materials are continuously removed from the papermaking raw material.

The cylinder shaped screen 1 and the first foils 2 are disposed in a tank 3 for receiving the papermaking raw material. The tank 3 is divided into a first chamber 3A and a second chamber 3B by the cylinder shaped screen 1. The tank 3 has a supply opening 3a for receiving the papermaking raw material; a papermaking raw material discharging opening 3a for discharging the papermaking raw material passing thorough the screen 1 to outside the tank 3; and a foreign material discharging opening 3c for discharging the papermaking raw material containing the foreign materials and not passing through the screen 1.

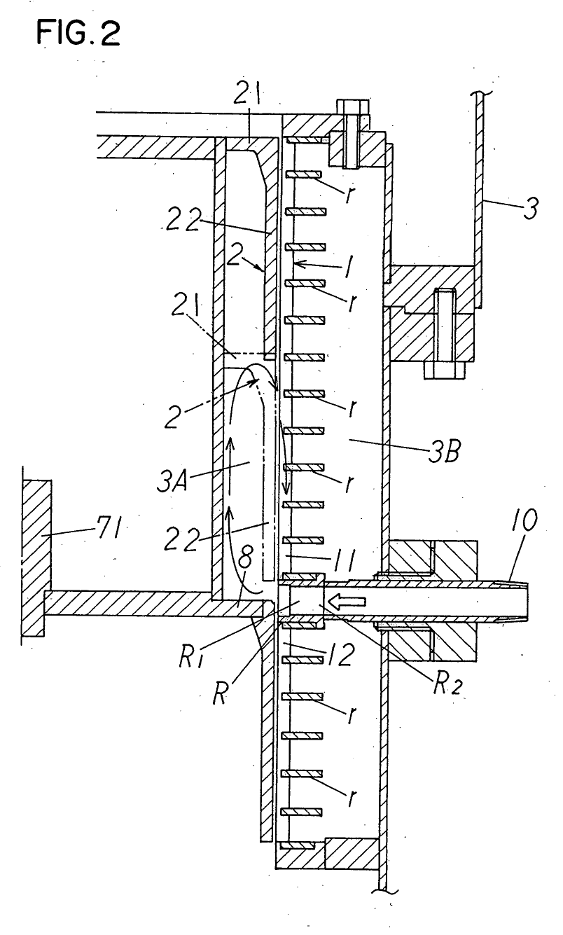

The screen 1 has many openings (not shown) in a side surface thereof, and rings r reinforce the screen 1. The screen 1 has a cylinder shaped screen portion 11 at an upper position thereof and a cylinder shaped screen portion 12 at a lower position thereof. The screen portions 11 and 12 are connected via a ring shaped portion R with a recess portion R1 disposed therebetween (refer to FIG. 2).

A supplying path 4 is connected to the first chamber 3A of the tank 3 for supplying the papermaking raw material to the tank 3. A foreign material discharging path 5 is connected to the first chamber 3A for discharging the papermaking raw material containing the foreign materials and not passing through the screen 1 to outside the tank 3. A papermaking raw material discharging path 6 is connected to the second chamber 3B for discharging the papermaking raw material passing through the screen 1.

The screen 1 has a plurality of openings (circle, or slit such as a thin rectangular shape) for passing the papermaking raw material through the side surface thereof. The screen 10 has an open top portion and an open bottom portion, and is fixed in the tank in a standing state.

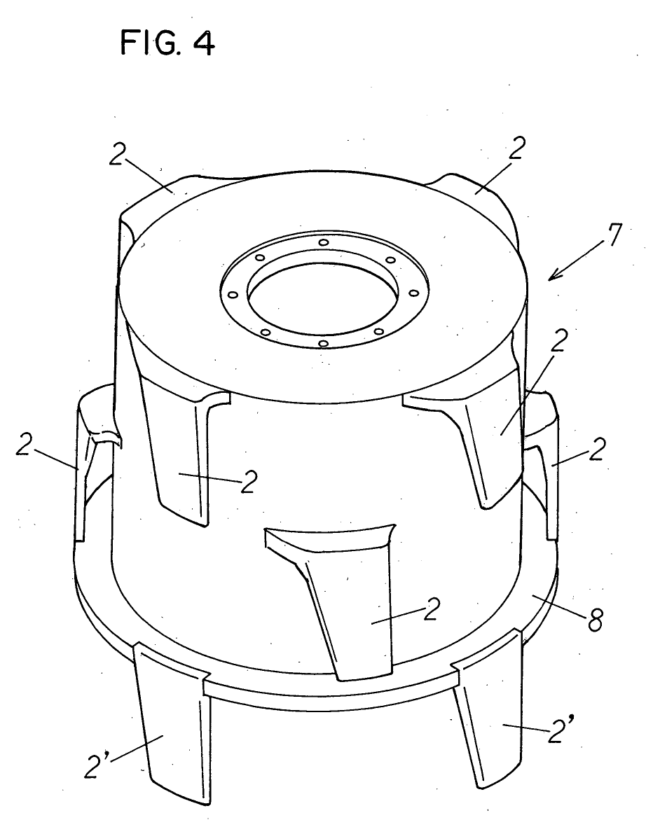

As shown in FIG. 4, the first foils 2 are provided (attached) on a side surface of the cylindrical member 7. Each of the first foils 2 has a protruding part 21 protruding from the side surface of the cylindrical member 7 and a hanging member 22 extending downwardly from the protruding part 21 and situated away from the side surface of the cylindrical member 7. The first foils 2 are disposed at multiple locations (in the embodiment, four first foils are disposed at an upper portion, and four first foils are disposed at an upper portion and arranged alternately relative to the first foils at the upper portion). The cylindrical member 7 is disposed in the first chamber 3A to face the cylinder shaped screen 1, and connected to a rotating axis 31.

An extending member 8 covers the bottom portion of the cylindrical member 7, and extends from the side surface of the cylindrical member 7. The extending member 8 is attached to a boss part 71 disposed in the cylindrical member 7. The extending member 8 is provided with second foil 2′ extending downwardly from an edge surface thereof (the second foil 2′ are disposed at multiple locations. For example, in the present embodiment, the second foils 2′ are disposed at four locations. The second foils 2′ are arranged alternately relative to the first foils 2 located at the lower portion). The first foils 2 and the second foils 2′ rotate together with the cylindrical member 7 with a motor (not shown) via a power transmission member 9 (for example, a belt).

The recess portion R1 is formed in the cylinder shaped screen 1 at a portion thereof facing the edge surface of the extending member 8. Dilution water supply openings R2 face the recess portion R1, and correspond to end portions of water supplying paths 10. The dilution water supply openings R2 face the recess portion R1 (for example, four openings are provided in the embodiment), so that water is horizontally sprayed from the dilution water supply openings R2.

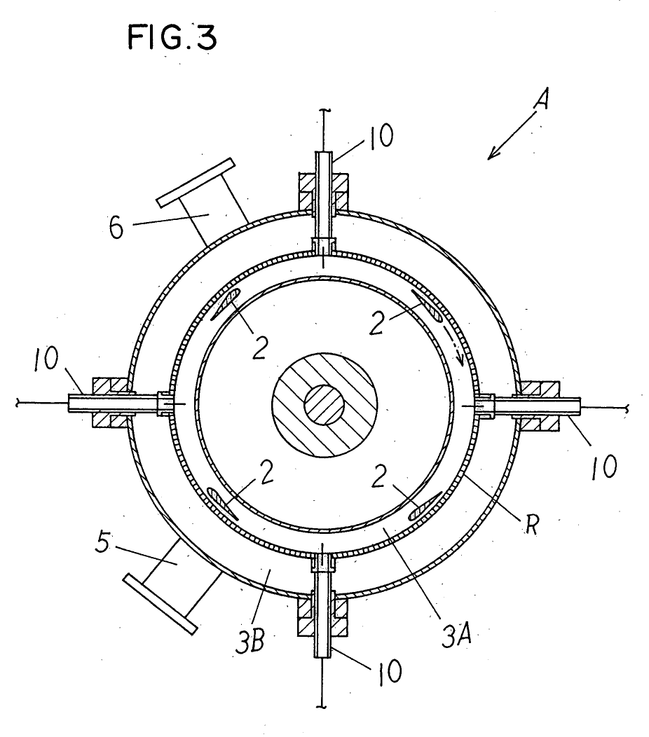

When the first foils 2 and the second foils 2′ rotate (in an arrow direction shown in FIG. 3), a positive pressure is generated with respect to the screen 1 at front portions of the first foils 2 and the second foils 2′, and a negative pressure with respect to the screen 1 is generated at rear portions of the first foils 2 and the second foils 2′. Accordingly, the papermaking raw material flows in reverse from the second chamber 3B to the first chamber 3A, thereby washing the openings of the screen 1. Therefore, it is possible to continuously remove the foreign materials from the papermaking raw material while preventing the foreign materials and the fibers in the papermaking raw material from clogging the openings of the screen 1.

The papermaking raw material is, led toward a downstream side of the screen 1 while being screened. However, the extending member 8 extends from the side surface of the cylindrical member 7, thereby blocking the papermaking raw material from flowing toward a downstream side. At the same time, a discharge pressure of the papermaking raw material increases due to rotation of the first foils 2, and the hanging members 22 of the first foils 2 are situated away from the side surface of the cylindrical member 7.

Accordingly, a part of the papermaking raw material is not blocked from flowing toward a downstream side. (If the hanging members of the first foils are not situated away from the side surface of the cylindrical member and just extend from the side surface of the cylindrical member, when the papermaking raw material hits against the extending member and tries to flow upwardly, the hanging members of the rotating first foils block the papermaking raw material). As shown in FIG. 2, a part of the papermaking raw material moves to an upper side of the first foils 2 along the cylindrical member 7, so that the papermaking raw material stays for a long time. As a result, the useful fibers in the papermaking raw material pass through the screen 1, thereby improving yield of the papermaking raw material. That is, the papermaking raw material stays in the tank 3 for a long time, thereby improving screening efficiency.

The papermaking raw material flowing toward a downstream, side is led to the recess portion R1, and is diluted in the recess portion R1 by dilution water. Accordingly, it is easy to loosen the papermaking raw material, thereby improving the screening efficiency. The dilution water is sprayed horizontally through a plurality of the dilution water supply openings R2 to form a water seal. Accordingly, the water seal blocks the papermaking raw material from flowing toward a downstream side, thereby improving the screening efficiency.

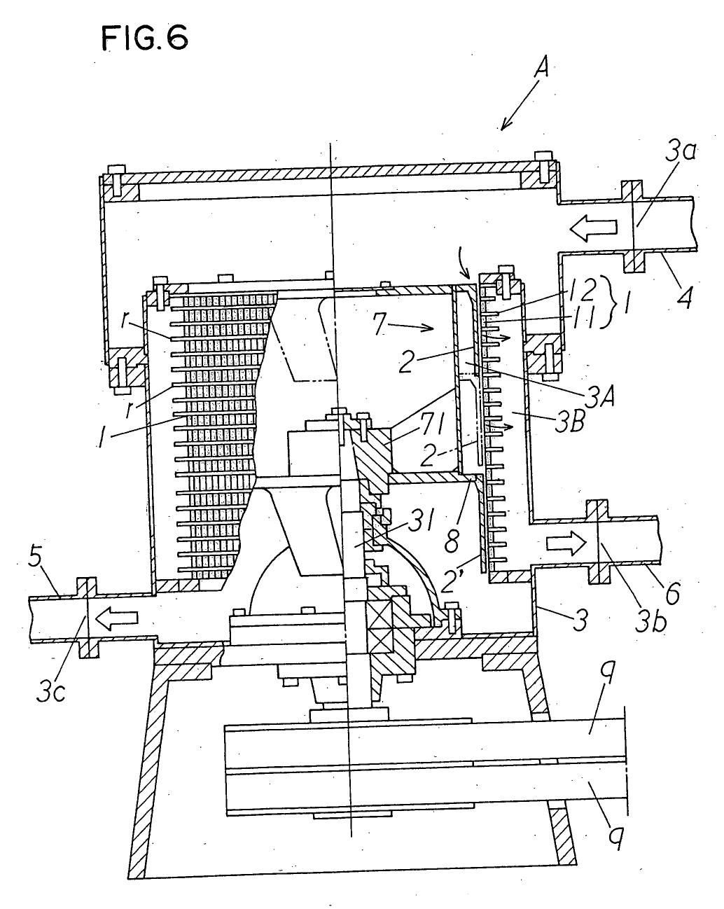

Moreover, when the papermaking raw material is led to the recess portion R1 and diluted in the recess portion R1 by the dilution water, the papermaking raw material is pressured by the second foils 2′. Accordingly, it is easy to loosen the papermaking raw material, thereby improving the screening efficiency. After passing through the screen 1, the papermaking raw material is discharged to outside the tank 3 via the papermaking raw material discharging path 6. The papermaking raw material containing the foreign materials and not passing through the screen 1 is discharged to outside the tank 3 via the foreign materials discharging path 5. As shown in FIG. 6, the water supplying paths 10 may be omitted.

The disclosure of Japanese Patent Application No. 2004-278724, filed on Sep. 27, 2004, is incorporated in the application.

While the invention has been explained with reference to the specific embodiments of the invention, the explanation is illustrative and the invention is limited only by the appended claims.

What is claimed is:

1. A screen device for screening a papermaking raw material, comprising;
a tank for receiving the papermaking raw material,
a cylindrical screen disposed in the tank for dividing the tank into a first chamber and a second chamber,
a papermaking raw material supplying path communicating with the first chamber for supplying the papermaking raw material to the tank,
a foreign material discharging path communicating with the first chamber for discharging the papermaking raw material containing foreign materials and not passing through the screen to outside the tank,
a papermaking raw material discharging path communicating with the second chamber for discharging the papermaking raw material passing through the screen to outside the tank,
a cylindrical member rotatably disposed in the first chamber to face the screen and having a side surface,
a plurality of first foils disposed on the cylindrical member, each first foil having a projecting portion projecting from the side surface of the cylindrical member and a hanging member extending downwardly from the projecting portion and situated away from the side surface of the cylindrical member, and
an extending member extending from the side surface of the cylindrical member at a lower portion of the cylindrical member.

2. A screen device according to claim 1, further comprising a plurality of second foils spaced apart from each other and extending downwardly from an outer edge of the extending member.

3. A screen device according to claim 2, wherein said plurality of first foils includes upper foils laterally spaced apart from each other, and lower foils situated under the upper foils to be laterally spaced apart from each other.

4. A screen device according to claim 3, wherein said lower foils are located between the upper foils, respectively.

5. A screen device according to claim 4, wherein said cylindrical member includes at least one recess at a portion facing the extending member.

6. A screen device according to claim 5, further comprising a water supply path connected to the at least one recess for supplying water inside the screen and outside the cylindrical member.
